(19) United States
(12) Patent Application Publication
(10) Pub. No.: US 2022/0069472 A1
(43) Pub. Date: Mar. 3, 2022

(54) ANTENNA DEVICE

(71) Applicant: MITSUBISHI ELECTRIC CORPORATION, Tokyo (JP)

(72) Inventors: Shingo YAMAURA, Tokyo (JP); Kengo NISHIMOTO, Tokyo (JP); Yasuhiro NISHIOKA, Tokyo (JP)

(73) Assignee: MITSUBISHI ELECTRIC CORPORATION, Tokyo (JP)

(21) Appl. No.: 17/523,446

(22) Filed: Nov. 10, 2021

Related U.S. Application Data
(63) Continuation of application No. PCT/JP2019/023507, filed on Jun. 13, 2019.

(51) Int. Cl. H01Q 9/30; H01Q 1/50

(52) U.S. Cl. CPC H01Q 9/30; H01Q 1/50

(57) ABSTRACT

An antenna device includes: a rod-shaped conductor disposed perpendicularly to a grounding face part; a plurality of first linear members supporting the rod-shaped conductor by a tension structure; a first bent conductor having a first linear conductor disposed so as to branch from the rod-shaped conductor and disposed so as to be inclined with respect to the grounding face part, and a second linear conductor disposed so as to be continuous with a distal end of the first linear conductor and disposed along a first linear member selected from among the plurality of first linear members; a first selective transmission part disposed at an end of the first linear conductor on the same side as the rod-shaped conductor; and a second selective transmission part disposed in the rod-shaped conductor. The rod-shaped conductor and the first bent conductor constitute a first antenna element part having a first electrical length corresponding to a first operation frequency, and a second antenna element part having a second electrical length corresponding to a second operation frequency.

### CROSS REFERENCE TO RELATED APPLICATIONS

This application is a Continuation of PCT International Application No. PCT/JP2019/023507, filed on Jun. 13, 2019, which is hereby expressly incorporated by reference into the present application.

### TECHNICAL FIELD

The present invention relates to an antenna device.

### BACKGROUND ART

Conventionally, in an antenna device for wireless communication, a technique for implementing a multiband by using a so-called “branch element” has been developed (see, for example, Patent Literature 1). That is, an antenna device that operates in a plurality of frequency bands by supplying a high-frequency current to a plurality of antenna elements from one power feeding part has been developed. In addition, in an antenna device using a branch element, a technique for suppressing electrical interference between antenna elements by disposing a filter between a power feeding part and at least one antenna element among a plurality of antenna elements has been developed (see, for example, Patent Literature 2).

### CITATION LIST

### Patent Literatures

Patent Literature 1: JP 2007-300398 A

Patent Literature 2: JP 2009-253959 A

### SUMMARY OF INVENTION

### Technical Problem

In an antenna device for wireless communication, improvement of so-called “antenna emission efficiency” is required. In addition, in an antenna device using a branch element, a structure thereof can be complicated, and therefore it is required to simplify the structure. Therefore, in an antenna device for wireless communication using a branch element, it is required to improve the antenna emission efficiency with a simple structure.

In addition, in the antenna device for wireless communication, it is also required to reduce a loss due to impedance mismatch between a power feeding part and an antenna element (hereinafter, referred to as “mismatch loss”) from a viewpoint of implementing a multiband. In addition, in the antenna device for wireless communication, it is also required to improve so-called “antenna gain” in an application for limiting a communication range.

The present invention has been made in order to solve the above problems, and an object of the present invention is to improve the antenna emission efficiency with a simple structure in a multiband antenna device using a branch element.

### Solution to Problem

An antenna device of the present invention includes: a rod-shaped conductor disposed perpendicularly to a grounding face part; a plurality of first linear members to support the rod-shaped conductor by a tension structure; a first bent conductor having a first linear conductor disposed so as to branch from the rod-shaped conductor and disposed so as to be inclined with respect to the grounding face part, and a second linear conductor disposed so as to be continuous with a distal end of the first linear conductor and disposed along a first linear member selected from among the plurality of first linear members; a first selective transmission part disposed at an end of the first linear conductor on the same side as the rod-shaped conductor; and a second selective transmission part disposed in the rod-shaped conductor, wherein the rod-shaped conductor and the first bent conductor constitute a first antenna element part having a first electrical length corresponding to a first operation frequency, and a second antenna element part having a second electrical length corresponding to a second operation frequency.

### Advantageous Effects of Invention

According to the present invention, with the above configuration, the antenna emission efficiency can be improved with a simple structure.

### BRIEF DESCRIPTION OF DRAWINGS

FIG. 1 is a side view illustrating a main part of an antenna device according to a first embodiment.

FIG. 2 is a perspective view illustrating the main part of the antenna device according to the first embodiment.

FIG. 3 is a perspective view illustrating a main part of another antenna device according to the first embodiment.

FIG. 4 is a perspective view illustrating a main part of an antenna device according to a second embodiment.

FIG. 5 is a perspective view illustrating a main part of an antenna device according to a third embodiment.

FIG. 6A is a characteristic diagram illustrating VSWR with respect to frequency.

FIG. 6B is another characteristic diagram illustrating VSWR with respect to frequency.

FIG. 7 is a characteristic diagram illustrating a directivity gain with respect to a horizontal face angle.

FIG. 8 is a perspective view illustrating a main part of an antenna device according to a fourth embodiment.

FIG. 9 is a side view illustrating a main part of another antenna device according to the fourth embodiment.

FIG. 10 is a perspective view illustrating a main part of an antenna device according to a fifth embodiment.

FIG. 11 is a side view illustrating a main part of an antenna device according to a sixth embodiment.

### DESCRIPTION OF EMBODIMENTS

Hereinafter, in order to describe the present invention in more detail, embodiments for performing the present invention will be described with reference to the attached drawings.

### First Embodiment

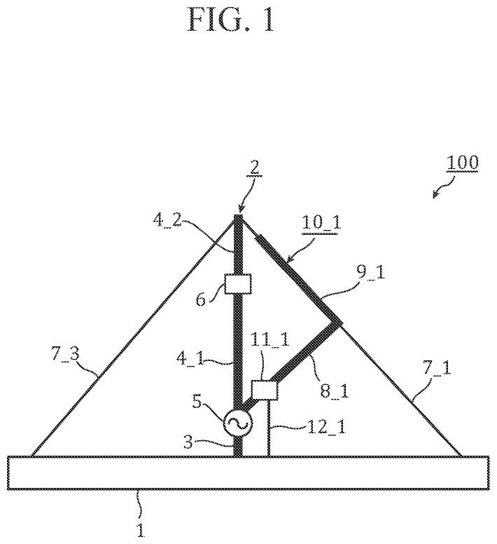

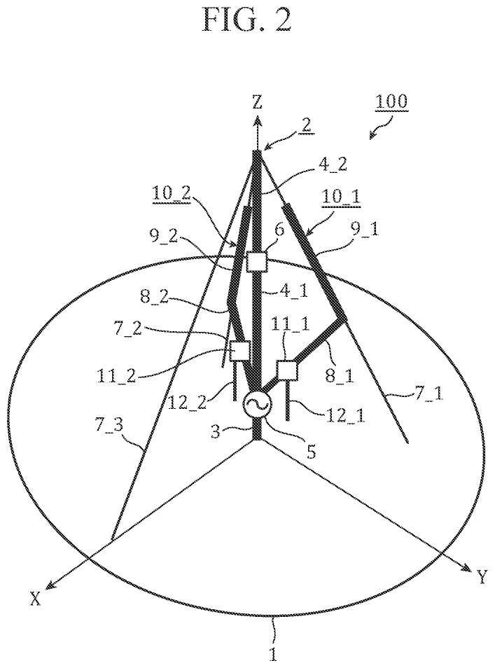

FIG. 1 is a side view illustrating a main part of an antenna device according to a first embodiment. FIG. 2 is a perspective view illustrating the main part of the antenna device according to the first embodiment. The antenna device according to the first embodiment will be described with reference to FIGS. 1 and 2.

In the drawings, reference numeral 1 denotes a face part for grounding (hereinafter, referred to as a “grounding face part”). The grounding face part 1 is, for example, the ground or a rooftop face of a building. The conductivity on the grounding face part 1 is lower than the conductivity of metal (for example, copper or aluminum). As illustrated in FIGS. 1 and 2, the grounding face part 1 is a face part on which an antenna device 100 is disposed.

The antenna device 100 includes a substantially rod-shaped conductor member (hereinafter, referred to as a “rod-shaped conductor”) 2. The rod-shaped conductor 2 is disposed perpendicularly to the grounding face part 1. Alternatively, the rod-shaped conductor 2 is disposed substantially perpendicularly to the grounding face part 1. Hereinafter, being disposed perpendicularly and being disposed substantially perpendicularly are collectively referred to as “being disposed perpendicularly”. A base part of the rod-shaped conductor 2 is electrically connected to the grounding face part 1.

The overall length of the rod-shaped conductor 2 is, for example, about several meters to several tens of meters. The overall length of the rod-shaped conductor 2 corresponds to the height of the antenna device 100. The rod-shaped conductor 2 includes one rod-shaped conductor 3 and a plurality of rod-shaped conductors 4. Specifically, for example, the rod-shaped conductor 2 includes one rod-shaped conductor 3 and two rod-shaped conductors 4_1 and 4_2. That is, the rod-shaped conductor 2 is formed by assembling these rod-shaped conductors 3 and 4.

A power feeding part 5 is disposed between the rod-shaped conductors 3 and 4_1. That is, the rod-shaped conductor 3 is disposed between the grounding face part 1 and the power feeding part 5. The rod-shaped conductor 3 is electrically connected to a portion of the power feeding part 5 on a ground potential side (hereinafter, also referred to as a “ground potential portion”). The rod-shaped conductor 4_1 is electrically connected to a portion of the power feeding part 5 on a positive potential side (hereinafter, also referred to as a “positive potential portion”). These portions are electrically connected to a power source by a power feeding cable (for example, a coaxial cable). The rod-shaped conductors 3 and 4_1 are electrically insulated from each other by an insulating material (not illustrated) in the power feeding part 5.

A selective transmission part 6 is disposed between the rod-shaped conductors 4_1 and 4_2. That is, the rod-shaped conductor 4_1 is disposed between the power feeding part 5 and the selective transmission part 6. The selective transmission part 6 blocks a predetermined frequency component of a current in the rod-shaped conductor 4 and allows another predetermined frequency component of the current to pass through the selective transmission part 6. The selective transmission part 6 is constituted by, for example, a dielectric block or a band rejection filter. The band rejection filter is constituted by, for example, a parallel resonance circuit using a capacitor and an inductor.

The rod-shaped conductor 2 is supported by a so-called “tension structure”. That is, the rod-shaped conductor 2 is supported by tension of a plurality of substantially linear members (hereinafter, referred to as “linear members”) 7. Specifically, for example, the rod-shaped conductor 2 is supported on the grounding face part 1 by tension of three linear members 7_1, 7_2, and 7_3. Each of the linear members 7 is made of resin. The tension structure can improve self-standing stability of the rod-shaped conductor 2.

The plurality of linear members 7 is arranged rotationally symmetrically when the antenna device 100 is viewed from above. Specifically, for example, the three linear members 7_1, 7_2, and 7_3 are arranged at intervals of 120 degrees when the antenna device 100 is viewed from above. Hereinafter, each of the linear members 7 may be referred to as a “first linear member”.

Hereinafter, a direction along a longitudinal direction of the rod-shaped conductor 2, that is, a direction along a height direction of the antenna device 100 is referred to as “Z direction”. In the drawings, Z axis indicates a virtual axis corresponding to the Z direction. In addition, among directions along the grounding face part 1, a direction along the linear member 7_3 when the antenna device 100 is viewed from above is referred to as “X direction”. In the drawings, X axis indicates a virtual axis corresponding to the X direction. In addition, among directions along the grounding face part 1, a direction orthogonal to the X direction is referred to as “Y direction”. In the drawings, Y axis indicates a virtual axis corresponding to the Y direction.

A substantially linear conductor member (hereinafter, referred to as a “linear conductor”) 8_1 is disposed so as to branch from the rod-shaped conductor 2. More specifically, the linear conductor 8_1 is disposed so as to branch from a base part of the rod-shaped conductor 4_1. A linear conductor 9_1 is disposed so as to be continuous with a distal end of the linear conductor 8_1. The linear conductor 9_1 is disposed along the linear member 7_1. A distal end of the linear conductor 9_1 is directed to a distal end of the rod-shaped conductor 2. Here, a gap is formed between a distal end of the rod-shaped conductor 4_2 and the distal end of the linear conductor 9_1. As a result, the distal end of the rod-shaped conductor 4_2 and the distal end of the linear conductor 9_1 are electrically insulated from each other.

These linear conductors 8_1 and 9_1 constitute a conductor member having a bent shape (hereinafter, referred to as a “bent conductor”) 10_1. The bent conductor 10_1 is made of, for example, a metal wire.

A linear conductor 8_2 is disposed so as to branch from the rod-shaped conductor 2. More specifically, the linear conductor 8_2 is disposed so as to branch from a base part of the rod-shaped conductor 4_1. A linear conductor 9_2 is disposed so as to be continuous with a distal end of the linear conductor 8_2. The linear conductor 9_2 is disposed along the linear member 7_2. A distal end of the linear conductor 9_2 is directed to the distal end of the rod-shaped conductor 2. Here, a gap is formed between the distal end of the rod-shaped conductor 4_2 and the distal end of the linear conductor 9_2. As a result, the distal end of the rod-shaped conductor 4_2 and the distal end of the linear conductor 9_2 are electrically insulated from each other.

The linear conductors 8_2 and 9_2 constitute a bent conductor 10_2. The bent conductor 10_2 is made of, for example, a metal wire.

That is, a plurality of (for example, two) linear conductors 8 is arranged so as to branch from the rod-shaped conductor 2. More specifically, the plurality of linear conductors 8 is arranged so as to branch from a base part of the rod-shaped conductor 4_1. The linear conductor 9 is disposed so as to be continuous with a distal end of each of the linear conductors 8. Each of the linear conductors 9 is disposed along a corresponding linear member 7 among the plurality of (for example, three) linear members 7. In other words, each of the linear conductors 9 is disposed along a linear member 7 selected from among the plurality of linear members 7. Each of the linear conductors 8 and a corresponding linear conductor 9 constitute the bent conductor 10.

Hereinafter, each of the linear conductors 8 may be referred to as a “first linear conductor”. In addition, each of the linear conductors 9 may be referred to as a “second linear conductor”. In addition, each of the bent conductors 10 may be referred to as a “first bent conductor”.

A selective transmission part 11 is disposed at a base part of each of the linear conductors 8. Specifically, for example, selective transmission parts 11_1 and 11_2 are arranged at base parts of the linear conductors 8_1 and 8_2, respectively. That is, each of the selective transmission parts 11 is disposed at an end of a corresponding linear conductor 8 on the same side as the power feeding part 5. Each of the selective transmission parts 11 blocks a predetermined frequency component of a current in a corresponding bent conductor 10 and allows another predetermined frequency component of the current to pass through each of the selective transmission parts 11.

Each of the selective transmission parts 11 is constituted by, for example, a low-pass filter using an inductor and a capacitor. The inductors are arranged electrically in series with each other. On the other hand, the capacitors are arranged electrically in parallel with each other. Therefore, one end of each of the capacitors is electrically connected to the grounding face part 1 by an electric wire 12 for grounding (see FIGS. 1 and 2). Alternatively, one end of each of the capacitors is electrically connected to the rod-shaped conductor 3 by the electric wire 12 for grounding (not illustrated).

Specifically, for example, one end of the capacitor in the selective transmission part 11_1 is electrically connected to the grounding face part 1 by an electric wire 12_1, and one end of the capacitor in the selective transmission part 11_2 is electrically connected to the grounding face part 1 by an electric wire 12_2 (see FIGS. 1 and 2). Alternatively, for example, one end of the capacitor in the selective transmission part 11_1 is electrically connected to the rod-shaped conductor 3 by the electric wire 12_1, and one end of the capacitor in the selective transmission part 11_2 is electrically connected to the rod-shaped conductor 3 by the electric wire 12_2 (not illustrated).

Each of the bent conductors 10 functions as an antenna element corresponding to a predetermined operation frequency (hereinafter, referred to as a “first operation frequency”) f1 (hereinafter, referred to as a “first antenna element”). Hereinafter, a portion functioning as the first antenna element is referred to as a “first antenna element part”. In addition, the first antenna element part is denoted by reference numeral “E1”.

In addition, the rod-shaped conductor 4_1 functions as an antenna element corresponding to a predetermined operation frequency higher than the first operation frequency f1 (hereinafter, referred to as a “second operation frequency”) f2 (hereinafter, referred to as a “second antenna element”). Hereinafter, a portion functioning as the second antenna element is referred to as a “second antenna element part”. In addition, the second antenna element part is denoted by reference numeral “E2”.

Hereinafter, in first to third, fifth, and sixth embodiments, the first antenna element part E1 and the second antenna element part E2 may be collectively simply referred to as an “antenna element part”. In addition, such an antenna element part may be denoted by reference numeral “E”.

An electrical length (hereinafter, referred to as a “first electrical length”) L1 of the first antenna element part E1 is set to a value corresponding to the first operation frequency f1. In addition, an electrical length of the second antenna element part E2 (hereinafter, referred to as a “second electrical length”) L2 is set to a value corresponding to the second operation frequency f2.

Specifically, for example, the first electrical length L1 is set to a value 0.375 times a wavelength λ1 corresponding to the first operation frequency f1. That is, the first electrical length L1 is set to a value larger than a value 0.25 times the wavelength λ1. The first antenna element part E1 functions as a so-called “monopole antenna”. On the other hand, the second electrical length L2 is set to a value 0.25 times a wavelength λ2 corresponding to the second operation frequency f2. As a result, the second antenna element part E2 also functions as a monopole antenna.

The first operation frequency f1 is set to, for example, a value equivalent to a predetermined frequency f0. The second operation frequency f2 is set to, for example, a value substantially twice the frequency f0. That is, the second operation frequency f2 is set to a value substantially twice the first operation frequency f1. In this case, a value 0.375 times the wavelength λ1 is equivalent to a value 0.75 times the wavelength λ2. In addition, a value 0.25 times the wavelength λ1 is equivalent to a value 0.5 times the wavelength λ2. That is, in this case, the first electrical length L1 is set to a value larger than a value 0.5 times the wavelength λ2. More specifically, the first electrical length L1 is set to a value 0.75 times the wavelength λ2.

A pass band in each of the selective transmission parts 11 is set to a band including the frequency f1 and is set to a band excluding the frequency f2. In other words, a cutoff band in each of the selective transmission parts 11 is set to a band excluding the frequency f1 and is set to a band including the frequency f2. On the other hand, a pass band in the selective transmission part 6 is set to a band excluding the frequency f1 and the frequency f2. In other words, an attenuation band in the selective transmission part 6 is set to a band including the frequency f1 and the frequency f2. Hereinafter, each of the selective transmission parts 11 may be referred to as a “first selective transmission part”. In addition, the selective transmission part 6 may be referred to as a “second selective transmission part”.

Each of the linear members 7 is disposed so as to be inclined with respect to the rod-shaped conductor 2. Therefore, each of the linear conductors 9 is also disposed so as to be inclined with respect to the rod-shaped conductor 2. An inclination angle θ of each of the linear members 7 with respect to the rod-shaped conductor 2, that is, an inclination angle θ of each of the linear conductors 9 with respect to the rod-shaped conductor 2 is set to a value corresponding to mechanical specifications and electrical specifications of the antenna device 100. Specifically, for example, the inclination angle θ is set to 45 degrees.

Each of the linear conductors 8 is disposed so as to be inclined with respect to the grounding face part 1. An inclination angle φ of each of the linear conductors 8 with respect to the grounding face part 1 is set to a value corresponding to electrical specifications of the antenna device 100. Specifically, for example, the inclination angle φ is set to 45 degrees.

The main part of the antenna device 100 is configured in this manner.

Next, an effect obtained by setting the first electrical length L1 to a value larger than a value 0.5 times the wavelength λ2 in the antenna device 100 will be described. More specifically, a function and an effect of reducing a mismatch loss when the antenna element part E is excited at the frequency f2 will be described.

In a case where the first electrical length L1 is set to a value 0.25 times the wavelength λ1 (that is, a value 0.5 times the wavelength λ2), when the antenna element part E is excited at the frequency f2, both ends of each of the bent conductors 10 are electrically opened. This is because the selective transmission part 11 is disposed at a base part of each of the linear conductors 8, and a gap is formed between the distal end of the rod-shaped conductor 4_2 and a distal end of each of the linear conductors 9.

As a result, resonance of a half wavelength occurs in each of the bent conductors 10. At this time, an electromagnetic coupling amount (hereinafter, simply referred to as a “coupling amount”) between the rod-shaped conductor 4_1 and each of the bent conductors 10 is maximized at the frequency f2. Therefore, a current excited by the rod-shaped conductor 4_1 has substantially the same amplitude and opposite phase with respect to a current excited by each of the bent conductors 10.

As a result, an emission resistance of the antenna element part E at the frequency f2 decreases. This makes it difficult to implement impedance matching with respect to the power feeding part 5 at the frequency f2. Specifically, for example, it is difficult to implement impedance matching for a 50 ohm (hereinafter, described as “Ω”) system measuring instrument.

Therefore, in the antenna device 100, as described above, the first electrical length L1 is set to a value larger than a value 0.25 times the wavelength λ1 (that is, a value larger than a value 0.5 times the wavelength λ2). More specifically, the first electrical length L1 is set to a value 0.375 times the wavelength λ1 (that is, a value 0.75 times the wavelength λ2). As a result, a coupling amount between the rod-shaped conductor 4_1 and each of the bent conductors 10 is maximized at a frequency lower than f2.

As a result, an emission resistance of the antenna element part E at the frequency f2 increases. This can make it easy to implement impedance matching with respect to the power feeding part 5 at the frequency f2. In other words, when the antenna element part E is excited at the frequency f2, a mismatch loss can be reduced.

Next, another effect obtained by setting the first electrical length L1 to a value larger than a value 0.5 times the wavelength λ2 in the antenna device 100 will be described. More specifically, a function and an effect of improving an antenna gain when the antenna element part E is excited at the frequency f2 will be described.

When the antenna element part E is excited at the frequency f2, a high-frequency current is excited in each of the bent conductors 10 by electromagnetic coupling between the rod-shaped conductor 4_1 and each of the bent conductors 10. At this time, each of the bent conductors 10 functions as a non-excitation element, and the rod-shaped conductor 4_1 functions as an excitation element. Depending on a phase relationship between a phase of a current excited in the non-excitation element (that is, each of the bent conductors 10) and a phase of a current excited in the excitation element (that is, the rod-shaped conductor 4_1), the non-excitation element functions as a reflector. As a result, a gain decreases in a negative direction on the X-axis and increases in a positive direction on the X-axis.

At this time, since the first electrical length L1 is set to a value larger than a value 0.25 times the wavelength λ1 (that is, a value larger than a value 0.5 times the wavelength λ2), the function of the reflector can be enhanced. Therefore, in the antenna device 100, as described above, the first electrical length L1 is set to a value 0.375 times the wavelength λ1 (that is, a value 0.75 times the wavelength λ2). As a result, when the antenna element part E is excited at the frequency f2, an antenna gain can be improved.

Next, an effect obtained by setting the first electrical length L1 to a value larger than a value 0.25 times the wavelength λ1 in the antenna device 100 will be described. More specifically, a function and an effect of reducing a mismatch loss when the antenna element part E is excited at the frequency f1 will be described.

The shape of each of the bent conductors 10 is a shape having a bent portion between the linear conductors 8 and 9. Therefore, in a case where the first electrical length L1 is set to a value 0.25 times the wavelength λ1, impedance in each of the bent conductors 10 is capacitive. Such capacitive impedance makes it difficult to implement impedance matching with respect to the power feeding part 5.

On the other hand, since the first electrical length L1 is set to a value larger than a value 0.25 times the wavelength λ1, a capacitance component of the impedance in each of the bent conductors 10 can be reduced. This can make it easy to implement impedance matching with respect to the power feeding part 5 at the frequency f1. In other words, when the antenna element part E is excited at the frequency f1, a mismatch loss can be reduced.

Next, an effect obtained by disposing each of the linear conductors 8 in such a manner that each of the linear conductors 8 is inclined with respect to the grounding face part 1 in the antenna device 100 will be described. More specifically, a function and an effect of improving the antenna emission efficiency will be described.

Normally, the length of the rod-shaped conductor 3 is set to a small value. For example, the length of the rod-shaped conductor 3 is set to a value 0.001 times the wavelength λ2. As illustrated in FIGS. 1 and 2, a branch portion between the rod-shaped conductor 4_1 and each of the linear conductors 8 (hereinafter, simply referred to as a “branch portion”) is disposed at a lower end of the rod-shaped conductor 4_1. That is, the branch portion is disposed at an end of the rod-shaped conductor 4_1 on the same side as the power feeding part 5.

Therefore, in a case where each of the linear conductors 8 is disposed in parallel to the grounding face part 1, a distance between the grounding face part 1 and each of the linear conductors 8 is small. As a result, an electromagnetic field is concentrated in a narrow region between the grounding face part 1 and each of the linear conductors 8. Therefore, when the grounding face part 1 has a lossy electrical constant due to the low conductivity on the grounding face part 1, a loss occurs in the narrow region. This reduces the antenna emission efficiency.

On the other hand, since each of the linear conductors 8 is disposed so as to be inclined with respect to the grounding face part 1, a distance between the grounding face part 1 and each of the linear conductors 8 can be large. As a result, it is possible to suppress concentration of an electromagnetic field in the narrow region. This can improve the antenna emission efficiency.

Note that since each of the linear conductors 8 is disposed so as to be inclined with respect to the grounding face part 1, the following effects can also be obtained. That is, even when the height of the antenna device 100 is limited, the first electrical length L1 can be ensured.

Next, an effect obtained by disposing each of the linear conductors 9 along a corresponding linear member 7 in the antenna device 100 will be described.

When the antenna device 100 is large, it is required to arrange the plurality of linear members 7 from a viewpoint of improving self-standing stability of the rod-shaped conductor 2. By arranging the linear conductors 9 along these linear members 7, a dedicated member for holding each of the bent conductors 10 can be unnecessary. This makes it possible to avoid an increase in the number of components of the antenna device 100. As a result, the structure of the antenna device 100 can be simplified, and an increase in manufacturing cost of the antenna device 100 can be suppressed.

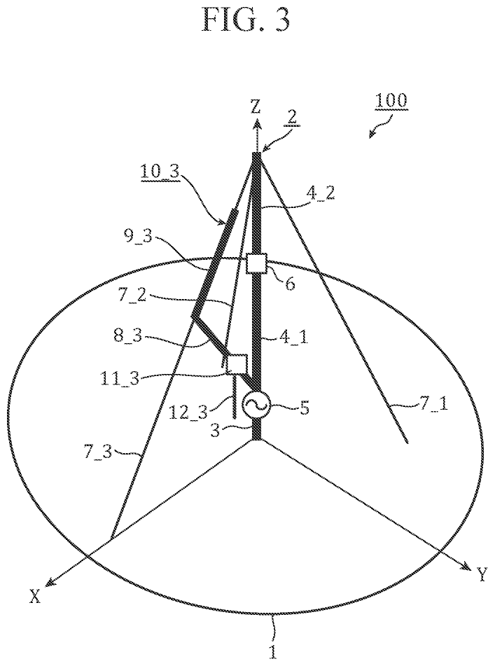

Next, a modification of the antenna device 100 will be described with reference to FIG. 3.

The antenna device 100 may include one bent conductor 10 instead of the plurality of bent conductors 10. For example, as illustrated in FIG. 3, the antenna device 100 may include one bent conductor 10_3 instead of the two bent conductors 10_1 and 10_2.

That is, a linear conductor 8_3 is disposed so as to branch from a base part of the rod-shaped conductor 4_1. A linear conductor 9_3 is disposed so as to be continuous with a distal end of the linear conductor 8_3. The linear conductor 9_3 is disposed along the linear member 7_3. A distal end of the linear conductor 9_3 is directed to a distal end of the rod-shaped conductor 4 2. The linear conductors 8_3 and 9_3 constitute a bent conductor 10_3.

A selective transmission part 11_3 is disposed at a base part of the linear conductor 8_3. The selective transmission part 11_3 is constituted by, for example, a low-pass filter using an inductor and a capacitor. One end of the capacitor is electrically connected to the grounding face part 1 or the rod-shaped conductor 3 by an electric wire 12_3.

Note that in the examples illustrated in FIGS. 1 and 2, as described above, a gain decreases in a negative direction on the X-axis and increases in a positive direction on the X-axis. On the other hand, in the example illustrated in FIG. 3, a gain increases in the negative direction on the X-axis and decreases in the positive direction on the X-axis.

Next, another modification of the antenna device 100 will be described.

The grounding face part 1 is not limited to the ground or a rooftop face of a building. For example, the grounding face part 1 may be a water surface. In this case, a substantially plate-shaped conductor member (hereinafter, referred to as a “plate-shaped conductor”) may be disposed along the grounding face part 1 from a viewpoint of implementing support of the rod-shaped conductor 2 by a tension structure. That is, the rod-shaped conductor 2 may be supported on the plate-shaped conductor by tension of the plurality of linear members 7. The plate-shaped conductor is constituted by, for example, a metal plate.

In addition, the rod-shaped conductor 4 may be formed by assembling three or more rod-shaped conductors. In this case, the selective transmission part 6 may be disposed between any two rod-shaped conductors among the three or more rod-shaped conductors.

In addition, each of the selective transmission parts 11 is not limited to a low-pass filter. For example, each of the selective transmission parts 11 may be configured by a band pass filter or a band rejection filter. These filters may be configured by a series resonant circuit using an inductor and a capacitor or a parallel resonant circuit using an inductor and a capacitor. Note that depending on circuit configurations of these filters, the electric wire 12 is unnecessary.

In addition, the antenna device 100 may include one selective transmission part 11 shared by the plurality of first antenna element parts E1 instead of the plurality of selective transmission parts 11 corresponding one-to-one to the plurality of first antenna element parts E1. For example, when base parts of the plurality of linear conductors 8 are electrically connected to a positive potential portion of the power feeding part 5, one selective transmission part 11 may be disposed in a connection portion thereof. As a result, the number of selective transmission parts 11 can be reduced, and the number of electric wires 12 can be reduced.

In addition, the number of linear members 7 is not limited to three. Four or more linear members 7 may be arranged depending on the overall length, weight, and the like of the rod-shaped conductor 2. In addition to the rod-shaped conductor 2 being supported by tension of the plurality of linear members 7, the rod-shaped conductor 2 may be supported by tension of the other plurality of linear members (not illustrated).

As described above, the antenna device 100 includes: the rod-shaped conductor 2 disposed perpendicularly to the grounding face part 1; the plurality of first linear members 7 supporting the rod-shaped conductor 2 by a tension structure; the first bent conductor 10 having the first linear conductor 8 disposed so as to branch from the rod-shaped conductor 2 and disposed so as to be inclined with respect to the grounding face part 1, and the second linear conductor 9 disposed so as to be continuous with a distal end of the first linear conductor 8 and disposed along a first linear member 7 selected from among the plurality of first linear members 7; the first selective transmission part 11 disposed at an end of the first linear conductor 8 on the same side as the rod-shaped conductor 2; and the second selective transmission part 6 disposed in the rod-shaped conductor 2. The rod-shaped conductor 2 and the first bent conductor 10 constitute the first antenna element part E1 having the first electrical length L1 corresponding to the first operation frequency f1, and the second antenna element part E2 having the second electrical length L2 corresponding to the second operation frequency f2. This can improve the antenna emission efficiency. In addition, this can simplify the structure of the antenna device 100.

In addition, the first electrical length L1 is set to a value larger than a value 0.5 times the wavelength λ2 corresponding to the second operation frequency f2. This can reduce a mismatch loss when the antenna element part E is excited at the frequency f2. In addition, this can improve an antenna gain when the antenna element part E is excited at the frequency f2.

In addition, the first antenna element part E1 is constituted by the bent conductor 10, and the second antenna element part E2 is constituted by a portion between the power feeding part 5 and the second selective transmission part 6 (rod-shaped conductor 4_1) in the rod-shaped conductor 2. This can implement the first antenna element part E1 and the second antenna element part E2.

### Second Embodiment

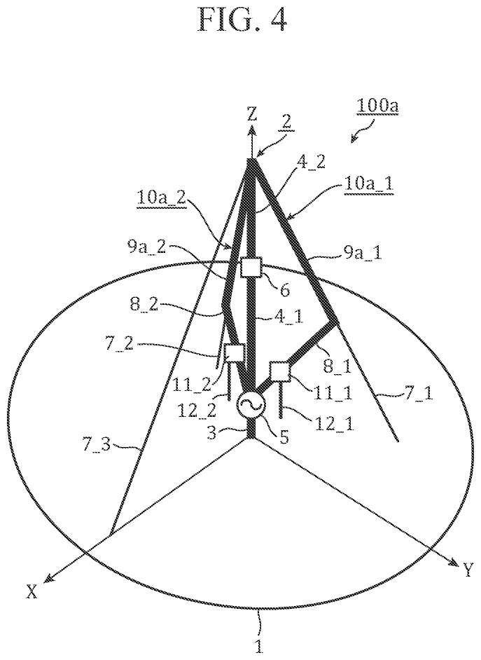

FIG. 4 is a perspective view illustrating a main part of an antenna device according to a second embodiment. The antenna device according to the second embodiment will be described with reference to FIG. 4. Note that in FIG. 4, the same reference numerals are given to components similar to those illustrated in FIGS. 1 and 2, and description thereof will be omitted.

A linear conductor 9a_1 is disposed so as to be continuous with a distal end of a linear conductor 8_1. The linear conductor 9a_1 is disposed along a linear member 7_1. A distal end of the linear conductor 9a_1 is directed to a distal end of a rod-shaped conductor 2. More specifically, the distal end of the linear conductor 9a_1 is directed to a distal end of a rod-shaped conductor 4_2. Here, the distal end of the linear conductor 9a_1 is disposed so as to be continuous with the distal end of the rod-shaped conductor 4_2. As a result, the distal end of the rod-shaped conductor 4_2 and the distal end of the linear conductor 9a_1 are electrically connected to each other. The linear conductors 8_1 and 9a_1 constitute a bent conductor 10a_1.

A linear conductor 9a_2 is disposed so as to be continuous with a distal end of a linear conductor 8_2. The linear conductor 9a_2 is disposed along a linear member 7_2. A distal end of the linear conductor 9a_2 is directed to a distal end of the rod-shaped conductor 2. More specifically, the distal end of the linear conductor 9a_2 is directed to a distal end of the rod-shaped conductor 4 2. Here, the distal end of the linear conductor 9a_2 is disposed so as to be continuous with the distal end of the rod-shaped conductor 4_2. As a result, the distal end of the rod-shaped conductor 4_2 and the distal end of the linear conductor 9a_2 are electrically connected to each other. The linear conductors 8_2 and 9a_2 constitute a bent conductor 10a_2.

That is, a plurality of (for example, two) linear conductors 8 is arranged so as to branch from the rod-shaped conductor 2. More specifically, the plurality of linear conductors 8 is arranged so as to branch from a base part of the rod-shaped conductor 4_1. The linear conductor 9a is disposed so as to be continuous with a distal end of each of the linear conductors 8. Each of the linear conductors 9a is disposed along a corresponding linear member 7 among the plurality of (for example, three) linear members 7. A distal end of each of the linear conductors 9a is disposed so as to be continuous with the distal end of the rod-shaped conductor 4_2. Each of the linear conductors 8 and a corresponding linear conductor 9a constitute the bent conductor 10a.

The rod-shaped conductor 4_2 and each of the bent conductors 10a constitute a first antenna element part E1. In addition, the rod-shaped conductor 4_1 constitutes a second antenna element part E2.

The main part of an antenna device 100a is configured in this manner.

By using a part of the rod-shaped conductor 2 (that is, the rod-shaped conductor 4_2) for the first antenna element part E1, the first electrical length L1 can be larger than that in the antenna device 100. That is, the first operation frequency f1 can be lower than that of the antenna device 100. In other words, impedance matching at a lower frequency can be implemented. In addition, even when the height of the antenna device 100a is limited, the first electrical length L1 can be ensured.

Note that as the antenna device 100a, various modifications similar to those described in the first embodiment can be adopted.

As described above, in the antenna device 100a, the second linear conductor 9a is disposed so as to be continuous with the distal end of the rod-shaped conductor 2, the first antenna element part E1 is constituted by a portion (rod-shaped conductor 4_2) of the rod-shaped conductor 2 between a second selective transmission part 6 and the distal end of the rod-shaped conductor 2 and the bent conductor 10a, and the second antenna element part E2 is constituted by a portion (rod-shaped conductor 4_1) of the rod-shaped conductor 2 between a power feeding part 5 and the second selective transmission part 6. This can increase the first electrical length L1. This can implement impedance matching at a lower frequency.

### Third Embodiment

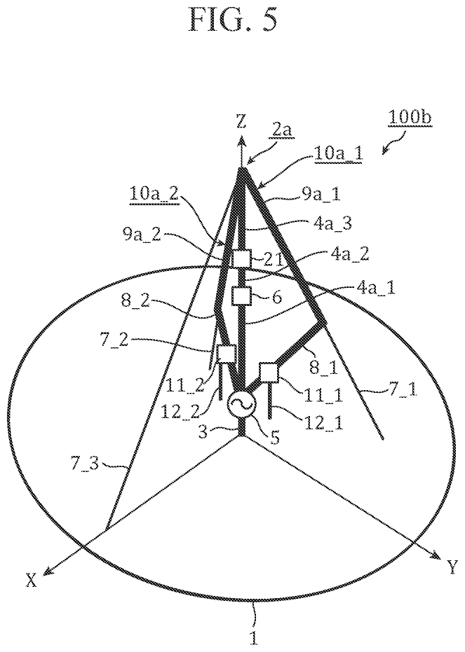

FIG. 5 is a perspective view illustrating a main part of an antenna device according to a third embodiment. The antenna device according to the third embodiment will be described with reference to FIG. 5. Note that in FIG. 5, the same reference numerals are given to components similar to those illustrated in FIG. 4, and description thereof will be omitted.

A rod-shaped conductor 2a includes one rod-shaped conductor 3 and a plurality of rod-shaped conductors 4a. Specifically, for example, the rod-shaped conductor 2a includes one rod-shaped conductor 3 and three rod-shaped conductors 4a_1, 4a_2, and 4a_3. That is, the rod-shaped conductor 2a is formed by assembling these rod-shaped conductors 3 and 4a.

A power feeding part 5 is disposed between the rod-shaped conductors 3 and 4a_1. In addition, a selective transmission part 6 is disposed between the rod-shaped conductors 4a_1 and 4a_2. That is, the rod-shaped conductor 4a_1 is disposed between the power feeding part 5 and the selective transmission part 6. In addition, a selective transmission part 21 is disposed between the rod-shaped conductors 4a_2 and 4a_3. That is, the rod-shaped conductor 4a_2 is disposed between the selective transmission parts 6 and 21.

A pass band in the selective transmission part 21 is set to a band similar to a transmission band in the selective transmission part 6. That is, the pass band in the selective transmission part 6 is set to a band excluding the frequency f1 and the frequency f2. In other words, an attenuation band in the selective transmission part 21 is set to a band similar to an attenuation band in the selective transmission part 6. That is, the attenuation band in the selective transmission part 6 is set to a band including the frequency f1 and the frequency f2.

The selective transmission part 21 is constituted by, for example, a dielectric block or a band rejection filter. The band rejection filter is constituted by, for example, a parallel resonance circuit using a capacitor and an inductor. Hereinafter, the selective transmission part 21 may be referred to as a “third selective transmission part”.

A distal end of each of linear conductors 9a is directed to a distal end of the rod-shaped conductor 2a. More specifically, the distal end of each of the linear conductors 9a is directed to a distal end of the rod-shaped conductor 4a_3. Here, the distal end of each of the linear conductors 9a is disposed so as to be continuous with the distal end of the rod-shaped conductor 4a_3. As a result, the distal end of the rod-shaped conductor 4a_3 and the distal end of each of the linear conductors 9a are electrically connected to each other.

The rod-shaped conductor 4a_3 and each of the bent conductors 10a constitute a first antenna element part E1. Therefore, the first electrical length L1 has a different value depending on the length of the rod-shaped conductor 4a_3. In other words, the first electrical length L1 has a different value depending on a position where the selective transmission part 21 is disposed with respect to a longitudinal direction (that is, the Z direction) of the rod-shaped conductor 2.

In addition, the rod-shaped conductor 4a_1 constitutes a second antenna element part E2. Therefore, the second electrical length L2 has a different value depending on the length of the rod-shaped conductor 4a_1. In other words, the second electrical length L2 has a different value depending on a position where the selective transmission part 6 is disposed with respect to a longitudinal direction (that is, the Z direction) of the rod-shaped conductor 2.

That is, the plurality of selective transmission parts 6 and 21 is arranged in the rod-shaped conductor 4a. The first electrical length L1 and the second electrical length L2 are individually set depending on positions where the selective transmission parts 6 and 21 are arranged. As a result, the first operation frequency f1 and the second operation frequency f2 can be individually set. In other words, the frequencies f1 and f2 that can implement impedance matching can be set independently of each other.

The main part of an antenna device 100b is configured in this manner.

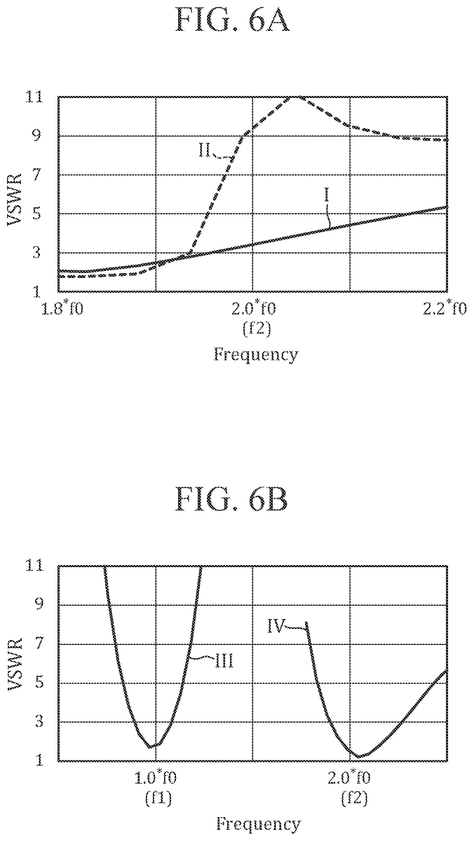

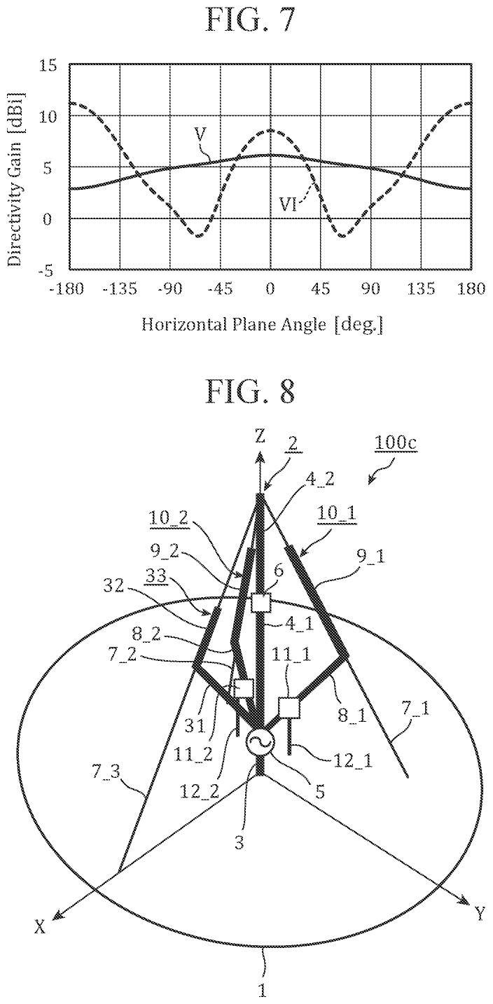

Next, an analysis result of the antenna device 100b will be described with reference to FIGS. 6 and 7.

In description related to FIGS. 6 and 7, a model corresponding to the antenna device 100b satisfying the following condition is referred to as a “first model”. That is, the length of the rod-shaped conductor 3 is set to a value 0.001 times the wavelength λ2. The overall length of the rod-shaped conductor 2a is set to a value 0.225 times the wavelength λ1 (that is, a value 0.45 times the wavelength λ2). The installation height of the selective transmission part 6 with respect to a grounding face part 1 is set to a value 0.25 times the wavelength λ2. An inclination angle θ of each of linear members 7 with respect to the rod-shaped conductor 2a (that is, an inclination angle θ of each of the linear conductors 9a) is set to 45 degrees. An inclination angle φ of each of linear conductors 8 with respect to the grounding face part 1 is set to 45 degrees. The first electrical length L1 is set to a value 0.375 times the wavelength λ1 (that is, a value 0.75 times the wavelength λ2). A distance between the power feeding part 5 and each of the selective transmission parts 11 is set to a value equal to or less than 0.001 times the wavelength λ2. Each of the selective transmission parts 11 allows a frequency component of f1 to pass by physical conduction and block a frequency component of f2 by physical non-conduction. A metal plate having an infinite size is disposed along the grounding face part 1, and the metal plate is electrically connected to a base part of the rod-shaped conductor 2.

In addition, in the antenna device 100 illustrated in FIGS. 1 and 2, a model corresponding to a case where the first electrical length L1 is set to a value 0.25 times the wavelength λ1 (that is, a value 0.5 times the wavelength λ2) is referred to as a “second model”. That is, the second model is a model for comparison with the first model.

In addition, a model corresponding to an antenna device (not illustrated) obtained by adding a matching circuit between the power feeding part 5 and a branch portion to the antenna device 100b according to the first model is referred to as a “third model”. This matching circuit is, for example, similar to a matching circuit described later in a sixth embodiment.

FIG. 6 is a characteristic diagram illustrating a voltage standing wave ratio (VSWR) with respect to frequency. A characteristic line I in FIG. 6A indicates VSWR in the first model. A characteristic line II in FIG. 6A indicates VSWR in the second model. The characteristic lines III and IV in FIG. 6B indicate VSWR in the third model.

As illustrated in FIG. 6A, when the second model is used, VSWR at the frequency f2 is large. This is because a current excited by the rod-shaped conductor 4_1 has substantially the same amplitude and opposite phase with respect to a current excited by each of the bent conductors 10. Therefore, it is difficult to implement impedance matching with respect to the power feeding part 5. On the other hand, when the first model is used, VSWR at the frequency f2 is small. This is because a coupling amount between the rod-shaped conductor 4a_1 and each of the bent conductors 10a is reduced. Therefore, by disposing the matching circuit as illustrated in FIG. 6B, favorable multiband characteristics can be obtained.

FIG. 7 is a characteristic diagram illustrating a directivity gain with respect to a horizontal face angle. Here, the horizontal face angle is an opening angle based on the positive direction on the X-axis, and is an opening angle along the grounding face part 1. A horizontal face angle of 0 degrees corresponds to the positive direction on the X axis. A horizontal face angle of plus 180 degrees and a horizontal face angle of minus 180 degrees correspond to the negative direction on the X-axis. A characteristic line V in FIG. 7 indicates a directivity gain in the first model. A characteristic line VI in FIG. 7 indicates a directivity gain in the second model.

Normally, when a single-element monopole antenna is disposed on a metal plate for grounding having an infinite size, a directivity gain of the monopole antenna is about 5 dBi. As illustrated in FIG. 7, when the second model is used, a directivity gain larger than 5 dBi is obtained in a direction corresponding to a horizontal face angle of 0 degrees. However, in this case, a directivity gain decreases in a direction corresponding to a horizontal face angle of plus 50 degrees and in a direction corresponding to a horizontal face angle of minus 50 degrees. Therefore, it is difficult to obtain a so-called “broad” directional characteristic.

On the other hand, when the first model is used, a directivity gain larger than 5 dBi is obtained in a direction corresponding to a horizontal face angle of 0 degrees. In addition, for an angular range including a horizontal face angle of 0 degrees, a directivity gain larger than 5 dBi is obtained over an angular range wider than an angular range in the second model. As a result, a broad directional characteristic can be obtained.

Here, an increase amount of the directivity gain is a value corresponding to the first electrical length L1, the second electrical length L2, the inclination angle θ, the inclination angle φ, and the like. Therefore, by setting these values, a desired increase amount can be implemented.

Note that as the antenna device 100b, various modifications similar to those described in the first embodiment can be adopted.

As described above, the antenna device 100b includes the third selective transmission part 21 disposed in the rod-shaped conductor 2a, in which the second linear conductor 9a is disposed so as to be continuous with the distal end of the rod-shaped conductor 2a, the first antenna element part E1 is constituted by a portion (rod-shaped conductor 4a_3) of the rod-shaped conductor 2a between the third selective transmission part 21 and the distal end of the rod-shaped conductor 2a and the bent conductor 10a, and the second antenna element part E2 is constituted by a portion (rod-shaped conductor 4a_1) of the rod-shaped conductor 2a between the power feeding part 5 and the second selective transmission part 6. As a result, the first electrical length L1 and the second electrical length L2 can be individually set depending on positions where the second selective transmission part 6 and the third selective transmission part 21 are arranged with respect to the longitudinal direction of the rod-shaped conductor 2a. As a result, the frequencies f1 and f2 that can implement impedance matching can be set independently of each other.

### Fourth Embodiment

FIG. 8 is a perspective view illustrating a main part of an antenna device according to a fourth embodiment. The antenna device according to the fourth embodiment will be described with reference to FIG. 8. Note that in FIG. 8, the same reference numerals are given to components similar to those illustrated in FIGS. 1 and 2, and description thereof will be omitted.

A linear conductor 31 is disposed so as to branch from a rod-shaped conductor 2. More specifically, the linear conductor 31 is disposed so as to branch from a base part of a rod-shaped conductor 4_1.

A linear conductor 32 is disposed so as to be continuous with a distal end of the linear conductor 31. The linear conductor 32 is disposed along a linear member 7_3. That is, the linear conductor 32 is disposed along the linear member 7_3 different from linear members 7_1 and 7_2 where linear conductors 9_1 and 9_2 are arranged among three linear members 7_1, 7_2, and 7_3. A distal end of the linear conductor 32 is directed to a distal end of the rod-shaped conductor 2. More specifically, the distal end of the linear conductor 32 is directed to a distal end of a rod-shaped conductor 4_2. Here, a gap is formed between the distal end of the rod-shaped conductor 4_2 and the distal end of the linear conductor 32. As a result, the distal end of the rod-shaped conductor 4_2 and the distal end of the linear conductor 32 are electrically insulated from each other.

The linear conductors 31 and 32 constitute a bent conductor 33. The bent conductor 33 is made of, for example, a metal wire.

Hereinafter, the linear conductor 31 may be referred to as a “third linear conductor”. In addition, the linear conductor 32 may be referred to as a “fourth linear conductor”. In addition, the bent conductor 33 may be referred to as a “second bent conductor”.

The bent conductor 33 functions as an antenna element corresponding to a predetermined operation frequency higher than the first operation frequency f1 (hereinafter, referred to as a “third operation frequency”) f3 (hereinafter, referred to as a “third antenna element”). Hereinafter, a portion functioning as the third antenna element is referred to as a “third antenna element part”. In addition, the third antenna element part is denoted by reference numeral “E3”.

An electrical length L3 of the third antenna element part E3 (hereinafter, referred to as a “third electrical length”) is set to a value corresponding to the third operation frequency f3. For example, the third operation frequency f3 is set to a value lower than the second operation frequency f2 (f1<f3<f2). Alternatively, for example, the third operation frequency f3 is set to a value higher than the second operation frequency f2 (f1<f2<f3).

That is, when the third operation frequency f3 is lower than the second operation frequency f2, the third electrical length L3 is larger than the second electrical length L2. On the other hand, when the third operation frequency f3 is higher than the second operation frequency f2, the third electrical length L3 is smaller than the second electrical length L2. As a result, a triple band can be implemented.

Hereinafter, in an antenna device 100c illustrated in FIG. 8, a first antenna element part E1, a second antenna element part E2, and the third antenna element part E3 may be collectively simply referred to as an “antenna element part”. In addition, such an antenna element part may be denoted by reference numeral “E”.

The linear conductor 31 is disposed so as to be inclined with respect to a grounding face part 1. An inclination angle α of the linear conductor 31 with respect to the grounding face part 1 is set to a value corresponding to electrical specifications of the antenna device 100c. For example, the inclination angle α is set to a value equivalent to an inclination angle φ of each of linear conductors 8 with respect to the grounding face part 1.

The main part of the antenna device 100c is configured in this manner.

When the antenna element part E is excited at the frequency f3, the rod-shaped conductor 4_1 and each of the bent conductors 10 function as reflectors, and therefore a gain increases in the positive direction on the X axis. This can improve an antenna gain. That is, the antenna gain can be improved by a principle similar to a principle that the antenna gain is improved when the antenna element part E is excited at the frequency f2.

In addition, since the linear conductor 32 is disposed along the linear member 7_3, a dedicated member for holding the linear conductor 32 can be unnecessary. This makes it possible to avoid an increase in the number of components of the antenna device 100c. As a result, the structure of the antenna device 100c can be simplified, and an increase in manufacturing cost of the antenna device 100c can be suppressed.

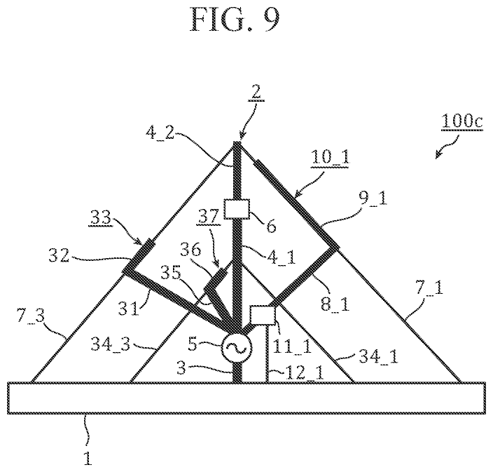

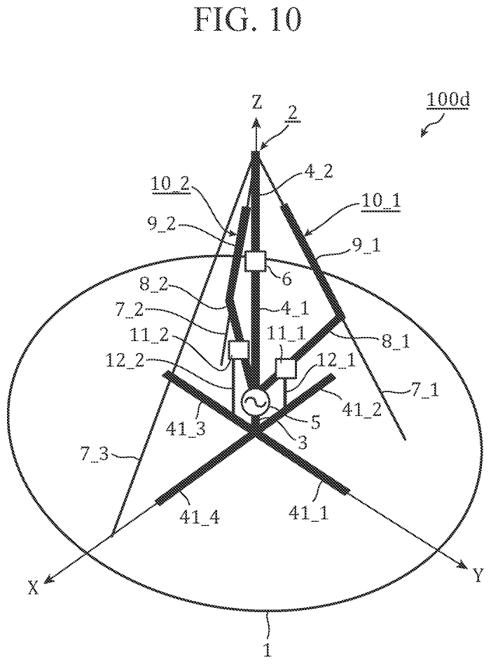

Next, a modification of the antenna device 100c will be described with reference to FIG. 9. In FIG. 9, the same reference numerals are given to components similar to those illustrated in FIG. 8, and description thereof will be omitted.

As illustrated in FIG. 9, in addition to the rod-shaped conductor 2 being supported by tension of the plurality of linear members 7, the rod-shaped conductor 2 is supported by tension of the other plurality of linear members 34. More specifically, in addition to the rod-shaped conductor 2 being supported on the grounding face part 1 by tension of the three linear members 7_1, 7_2, and 7_3, the rod-shaped conductor 2 is supported on the grounding face part 1 by tension of three linear members 34_1, 34_2, and 34_3. In FIG. 9, the linear members 7_2 and 34 2 are not illustrated.

A linear conductor 35 is disposed so as to branch from the rod-shaped conductor 2. More specifically, the linear conductor 35 is disposed so as to branch from a base part of the rod-shaped conductor 4_1. A linear conductor 36 is disposed so as to be continuous with a distal end of the linear conductor 35. The linear conductor 36 is disposed along the linear member 34_3. A distal end of the linear conductor 36 is directed to a center of the rod-shaped conductor 4_1. Here, a gap is formed between the center of the rod-shaped conductor 4_1 and the distal end of the linear conductor 36. As a result, the center of the rod-shaped conductor 4_1 and the distal end of the linear conductor 36 are electrically insulated from each other.

The linear conductors 35 and 36 constitute a bent conductor 37. The bent conductor 37 is made of, for example, a metal wire.

Hereinafter, the linear conductor 35 may be referred to as a “fifth linear conductor”. In addition, the linear conductor 36 may be referred to as a “sixth linear conductor”. In addition, the bent conductor 37 may be referred to as a “third bent conductor”.

The bent conductor 37 functions as an antenna element corresponding to a predetermined operation frequency higher than the first operation frequency f1 (hereinafter, referred to as a “fourth operation frequency”) f4 (hereinafter, referred to as a “fourth antenna element”). Hereinafter, a portion functioning as the fourth antenna element is referred to as a “fourth antenna element part”. In addition, the fourth antenna element part is denoted by reference numeral “E4”.

An electrical length of the fourth antenna element part E4 (hereinafter, referred to as a “fourth electrical length”) L4 is set to a value corresponding to the fourth operation frequency f4. For example, the fourth operation frequency f4 is set to a value different from the second operation frequency f2 and is set to a value different from the third operation frequency f3. As a result, a quad band can be implemented.

Hereinafter, in an antenna device 100c illustrated in FIG. 9, the first antenna element part E1, the second antenna element part E2, the third antenna element part E3, and the fourth antenna element part E4 may be collectively simply referred to as an “antenna element part”. In addition, such an antenna element part may be denoted by reference numeral “E”.

Each of the linear members 34 is disposed so as to be inclined with respect to the rod-shaped conductor 2. Therefore, the linear conductor 36 is also disposed so as to be inclined with respect to the rod-shaped conductor 2. An inclination angle β of each of the linear members 34 with respect to the rod-shaped conductor 2, that is, an inclination angle β of the linear conductor 36 with respect to the rod-shaped conductor 2 is set to a value corresponding to mechanical specifications and electrical specifications of the antenna device 100c. For example, the inclination angle β is set to a value equivalent to an inclination angle θ of each of the linear members 7 with respect to the rod-shaped conductor 2, that is, an inclination angle θ of each of the linear conductors 9 with respect to the rod-shaped conductor 2.

The linear conductor 35 is disposed so as to be inclined with respect to the grounding face part 1. An inclination angle γ of the linear conductor 35 with respect to the grounding face part 1 is set to a value corresponding to electrical specifications of the antenna device 100c. For example, the inclination angle γ is set to a value equivalent to an inclination angle φ of each of the linear conductors 8 with respect to the grounding face part 1.

By increasing the number of antenna element parts E in this manner, the number of frequencies at which impedance matching can be implemented can be increased. In addition, by increasing the number of antenna element parts E arranged radially with respect to the Z axis, the antenna device 100c similar to a so-called “bowtie antenna” can be implemented. As a result, a frequency band in which impedance matching can be implemented can be widened.

Note that the antenna device 100c illustrated in FIG. 9 includes the bent conductor 37 in addition to the bent conductor 33. That is, the antenna device 100c illustrated in FIG. 9 includes the fourth antenna element part E4 in addition to the third antenna element part E3. On the other hand, the antenna device 100c may include the bent conductor 37 instead of the bent conductor 33. That is, the antenna device 100c may include the fourth antenna element part E4 instead of the third antenna element part E3. As a result, a triple band can be implemented.

In addition, as the antenna device 100c, various modifications similar to those described in the first embodiment can be adopted.

As described above, the antenna device 100c includes the second bent conductor 33 having the third linear conductor 31 disposed so as to branch from the rod-shaped conductor 2 and disposed so as to be inclined with respect to the grounding face part 1 and the fourth linear conductor 32 disposed so as to be continuous with a distal end of the third linear conductor 31 and disposed along the other first linear member 7 among the plurality of first linear members 7, in which the second bent conductor 33 constitutes the third antenna element part E3 having the third electrical length L3 corresponding to the third operation frequency f3. As a result, for example, a triple band can be implemented.

In addition, the antenna device 100c includes the plurality of second linear members 34 supporting the rod-shaped conductor 2 by a tension structure, and the third bent conductor 37 having the fifth linear conductor 35 disposed so as to branch from the rod-shaped conductor 2 and disposed so as to be inclined with respect to the grounding face part 1, and the sixth linear conductor 36 disposed so as to be continuous with a distal end of the fifth linear conductor 35 and disposed along a second linear member 34 selected from among the plurality of second linear members 34, in which the third bent conductor 37 constitutes the fourth antenna element part E4 having the fourth electrical length L4 corresponding to the fourth operation frequency f4. As a result, for example, a quad band can be implemented.

### Fifth Embodiment

FIG. 10 is a perspective view illustrating a main part of an antenna device according to a fifth embodiment. The antenna device according to the fifth embodiment will be described with reference to FIG. 10. Note that in FIG. 10, the same reference numerals are given to components similar to those illustrated in FIGS. 1 and 2, and description thereof will be omitted.

As illustrated in FIG. 10, a plurality of linear conductors 41 is arranged along a grounding face part 1. A base part of each of the linear conductors 41 is electrically connected to a base part of a rod-shaped conductor 2. That is, the base part of each of the linear conductors 41 is electrically connected to a base part of a rod-shaped conductor 3. The plurality of linear conductors 41 is arranged radially with respect to the Z axis.

Specifically, for example, four linear conductors 41_1, 41_2, 41_3, and 41_4 are arranged. The four linear conductors 41_1, 41_2, 41_3, and 41_4 are arranged at intervals of 90 degrees when an antenna device 100d is viewed from above.

Hereinafter, each of the linear conductors 41 may be referred to as a “seventh linear conductor”.

Each of the linear conductors 41 is made of a material (for example, metal) having higher conductivity than the conductivity on the grounding face part 1. Specifically, for example, each of the linear conductors 41 is made of copper or aluminum.

The main part of the antenna device 100d is configured in this manner.

Each of antenna element parts E functions as a monopole antenna. That is, the antenna device 100d has a structure in which a large current flows through the grounding face part 1. In a case where the linear conductor 41 is not disposed, the conductivity on the grounding face part 1 is low, and therefore a loss due to the grounding face part 1 increases. On the other hand, since the linear conductor 41 having higher conductivity than the conductivity on the grounding face part 1 is disposed, such a loss can be reduced. As a result, the antenna emission efficiency can be further improved.

Next, a modification of the antenna device 100d will be described.

The number of linear conductors 41 is not limited to four. By increasing the number of linear conductors 41, an effect of reducing the loss can be enhanced. In addition, by lengthening each of the linear conductors 41, the effect of reducing the loss can be enhanced.

Arrangement of the plurality of linear conductors 41 is not limited to a radial arrangement. For example, the plurality of linear conductors 41 may be arranged in a mesh shape. However, by increasing an arrangement density of the linear conductors 41 in a region including a base part of the rod-shaped conductor 2, the effect of reducing the loss can be enhanced. This is because a current in the region is larger than a current in other regions. Therefore, the plurality of linear conductors 41 is preferably arranged in such a manner that the arrangement density in the region including the base part of the rod-shaped conductor 2 is high.

In addition, a gap may be formed between the grounding face part 1 and each of the linear conductors 41.

In addition, as the antenna device 100d, various modifications similar to those described in the first embodiment can be adopted.

As described above, the antenna device 100d includes the plurality of seventh linear conductors 41 electrically connected to the rod-shaped conductor 2 and disposed along the grounding face part 1. This can further improve the antenna emission efficiency.

### Sixth Embodiment

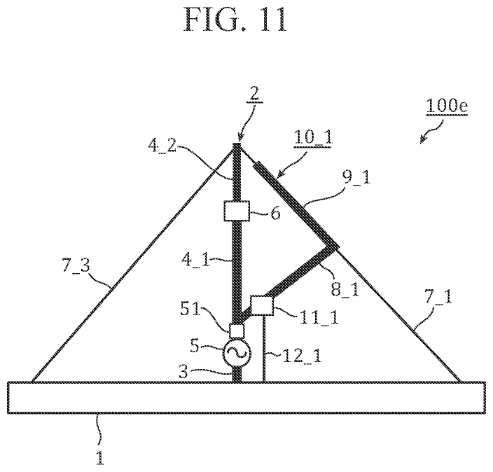

FIG. 11 is a side view illustrating a main part of an antenna device according to a sixth embodiment. The antenna device according to the sixth embodiment will be described with reference to FIG. 11. Note that in FIG. 11, the same reference numerals are given to components similar to those illustrated in FIGS. 1 and 2, and description thereof will be omitted.

As illustrated in FIG. 11, a matching circuit 51 is disposed between a power feeding part 5 and a branch portion. The matching circuit 51 is constituted by, for example, an inductor, a capacitor, a transformer, or an impedance converter.

The main part of an antenna device 100e is configured in this manner.

By using the matching circuit 51, impedance matching with respect to the power feeding part 5 can be implemented more easily than that in the antenna device 100. As a result, a mismatch loss can be further reduced.

Note that instead of the single matching circuit 51 shared by a plurality of antenna element parts E, a plurality of matching circuits 51 corresponding one-to-one to the plurality of antenna element parts E may be arranged.

For example, when each of a plurality of linear conductors 8 is electrically connected to a positive potential portion of the power feeding part 5, the matching circuit 51 for a first antenna element part E1 (hereinafter, also referred to as a “first matching circuit”) may be disposed between the positive potential side portion and each of a plurality of linear conductors 8. That is, the first matching circuit 51 may be disposed at an end of each of the first antenna element parts E1 on the same side as the power feeding part 5. In addition, when the rod-shaped conductor 4_1 is electrically connected to the positive potential portion of the power feeding part 5, the matching circuit 51 for the second antenna element part E2 (hereinafter, also referred to as a “second matching circuit”) may be disposed between the positive potential portion and the rod-shaped conductor 4_1. That is, the second matching circuit 51 may be disposed at an end of the second antenna element part E2 on the same side as the power feeding part 5.

In addition, the matching circuit 51 may be electrically connected to the grounding face part 1 or the rod-shaped conductor 3 by an electric wire for grounding (not illustrated). Whether such an electric wire is necessary or not varies depending on a circuit configuration of the matching circuit 51.

In addition, as the antenna device 100e, various modifications similar to those described in the first embodiment can be adopted.

As described above, the antenna device 100e includes the power feeding part 5 for the first antenna element part E1 and the second antenna element part E2, and the matching circuit 51 disposed between the power feeding part 5 and the branch portion between the first antenna element part E1 and the second antenna element part E2. Since the matching circuit 51 is disposed, a mismatch loss can be further reduced.

Alternatively, the antenna device 100e includes the power feeding part 5 for the first antenna element part E1 and the second antenna element part E2, and the plurality of matching circuits 51 including the first matching circuit 51 disposed at an end of the first antenna element part E1 on the same side as the power feeding part 5, and the second matching circuit 51 disposed at an end of the second antenna element part E2 on the same side as the power feeding part 5. Since the plurality of matching circuits 51 is arranged, a mismatch loss can be further reduced.

Note that the present invention can freely combine the embodiments to each other, modify any constituent element in each of the embodiments, or omit any constituent element in each of the embodiments within the scope of the invention.

### INDUSTRIAL APPLICABILITY

The antenna device of the present invention can be used, for example, for wireless communication.

### REFERENCE SIGNS LIST

1: Grounding face part,
2, 2a: Rod-shaped conductor,
3: Rod-shaped conductor,
4, 4a: Rod-shaped conductor,
5: Power feeding part,
6: Selective transmission part (second selective transmission part),
7: Linear member (first linear member),
8: Linear conductor (first linear conductor),
9, 9a: Linear conductor (second linear conductor),
10, 10a: Bent conductor (first bent conductor),
11: Selective transmission part (first selective transmission part),
12: Electric wire,
21: Selective transmission part (third selective transmission part),
31: Linear conductor (third linear conductor),
32: Linear conductor (fourth linear conductor),
33: Bent conductor (second bent conductor),
34: Linear member (second linear member),
35: Linear conductor (fifth linear conductor),
36: Linear conductor (sixth linear conductor),
37: Bent conductor (third bent conductor),
41: Linear conductor (seventh linear conductor),
51: Matching circuit,
100, 100a, 100b, 100c, 100d, 100e: Antenna device

What is claimed is:

1. An antenna device comprising:
a rod-shaped conductor disposed perpendicularly to a grounding face part;
a plurality of first linear members to support the rod-shaped conductor by a tension structure;
a first bent conductor having a first linear conductor disposed so as to branch from the rod-shaped conductor and disposed so as to be inclined with respect to the grounding face part, and a second linear conductor disposed so as to be continuous with a distal end of the first linear conductor and disposed along a first linear member selected from among the plurality of first linear members;
a first selective transmission part disposed at an end of the first linear conductor on the same side as the rod-shaped conductor; and
a second selective transmission part disposed in the rod-shaped conductor, wherein
the rod-shaped conductor and the first bent conductor constitute a first antenna element part having a first electrical length corresponding to a first operation frequency, and a second antenna element part having a second electrical length corresponding to a second operation frequency.

2. The antenna device according to claim 1, wherein the first electrical length is set to a value larger than a value 0.5 times a wavelength corresponding to the second operation frequency.

3. The antenna device according to claim 1, wherein
the first antenna element part is constituted by the bent conductor, and
the second antenna element part is constituted by a portion of the rod-shaped conductor between a power feeding part and the second selective transmission part.

4. The antenna device according to claim 1, wherein
the second linear conductor is disposed so as to be continuous with a distal end of the rod-shaped conductor,
the first antenna element part is constituted by a portion of the rod-shaped conductor between the second selective transmission part and the distal end of the rod-shaped conductor and the bent conductor, and
the second antenna element part is constituted by a portion of the rod-shaped conductor between a power feeding part and the second selective transmission part.

5. The antenna device according to claim 1, further comprising a third selective transmission part disposed in the rod-shaped conductor, wherein
the second linear conductor is disposed so as to be continuous with a distal end of the rod-shaped conductor,
the first antenna element part is constituted by a portion of the rod-shaped conductor between the third selective transmission part and the distal end of the rod-shaped conductor and the bent conductor, and
the second antenna element part is constituted by a portion of the rod-shaped conductor between a power feeding part and the second selective transmission part.

6. The antenna device according to claim 1, further comprising a second bent conductor having a third linear conductor disposed so as to branch from the rod-shaped conductor and disposed so as to be inclined with respect to the grounding face part and a fourth linear conductor disposed so as to be continuous with a distal end of the third linear conductor and disposed along another first linear member among the plurality of first linear members, wherein
the second bent conductor constitutes a third antenna element part having a third electrical length corresponding to a third operation frequency.

7. The antenna device according to claim 1, further comprising:
a plurality of second linear members to support the rod-shaped conductor by a tension structure; and
a third bent conductor having a fifth linear conductor disposed so as to branch from the rod-shaped conductor and disposed so as to be inclined with respect to the grounding face part, and a sixth linear conductor disposed so as to be continuous with a distal end of the fifth linear conductor and disposed along a second linear member selected from among the plurality of second linear members, wherein
the third bent conductor constitutes a fourth antenna element part having a fourth electrical length corresponding to a fourth operation frequency.

8. The antenna device according to claim 1, further comprising a plurality of seventh linear conductors electrically connected to the rod-shaped conductor and arranged along the grounding face part.

9. The antenna device according to claim 1, further comprising:
a power feeding part for the first antenna element part and the second antenna element part; and
a matching circuit disposed between the power feeding part and a branch portion between the first antenna element part and the second antenna element part.

10. The antenna device according to claim 1, further comprising:
a power feeding part for the first antenna element part and the second antenna element part; and
a plurality of matching circuits including a first matching circuit disposed at an end of the first antenna element part on the same side as the power feeding part, and a second matching circuit disposed at an end of the second antenna element part on the same side as the power feeding part.

11. The antenna device according to claim 2, wherein
the first antenna element part is constituted by the bent conductor, and
the second antenna element part is constituted by a portion of the rod-shaped conductor between a power feeding part and the second selective transmission part.

12. The antenna device according to claim 2, wherein
the second linear conductor is disposed so as to be continuous with a distal end of the rod-shaped conductor,
the first antenna element part is constituted by a portion of the rod-shaped conductor between the second selective transmission part and the distal end of the rod-shaped conductor and the bent conductor, and
the second antenna element part is constituted by a portion of the rod-shaped conductor between a power feeding part and the second selective transmission part.

13. The antenna device according to claim 2, further comprising a third selective transmission part disposed in the rod-shaped conductor, wherein
the second linear conductor is disposed so as to be continuous with a distal end of the rod-shaped conductor,
the first antenna element part is constituted by a portion of the rod-shaped conductor between the third selective transmission part and the distal end of the rod-shaped conductor and the bent conductor, and
the second antenna element part is constituted by a portion of the rod-shaped conductor between a power feeding part and the second selective transmission part.

14. The antenna device according to claim 2, further comprising a second bent conductor having a third linear conductor disposed so as to branch from the rod-shaped conductor and disposed so as to be inclined with respect to the grounding face part and a fourth linear conductor disposed so as to be continuous with a distal end of the third linear conductor and disposed along another first linear member among the plurality of first linear members, wherein
the second bent conductor constitutes a third antenna element part having a third electrical length corresponding to a third operation frequency.

15. The antenna device according to claim 2, further comprising:
a plurality of second linear members to support the rod-shaped conductor by a tension structure; and
a third bent conductor having a fifth linear conductor disposed so as to branch from the rod-shaped conductor and disposed so as to be inclined with respect to the grounding face part, and a sixth linear conductor disposed so as to be continuous with a distal end of the fifth linear conductor and disposed along a second linear member selected from among the plurality of second linear members, wherein
the third bent conductor constitutes a fourth antenna element part having a fourth electrical length corresponding to a fourth operation frequency.

16. The antenna device according to claim 2, further comprising a plurality of seventh linear conductors electrically connected to the rod-shaped conductor and arranged along the grounding face part.

17. The antenna device according to claim 2, further comprising:
a power feeding part for the first antenna element part and the second antenna element part; and
a matching circuit disposed between the power feeding part and a branch portion between the first antenna element part and the second antenna element part.

18. The antenna device according to claim 2, further comprising:
a power feeding part for the first antenna element part and the second antenna element part; and
a plurality of matching circuits including a first matching circuit disposed at an end of the first antenna element part on the same side as the power feeding part, and a second matching circuit disposed at an end of the second antenna element part on the same side as the power feeding part.
